(19) United States
(12) Patent Application Publication
(10) Pub. No.: US 2026/0310987 A1
(43) Pub. Date: Oct. 8, 2026

(54) CONTRASTIVE LEARNING IN A FEDERATED ENVIRONMENT

(71) Applicant: QUALCOMM Incorporated, San Diego, CA (US)

(72) Inventors: Christos LOUIZOS, Amsterdam (NL); Matthias REISSER, Palo Alto, CA (US); Denis KORZHENKOV, Amsterdam (NL)

(21) Appl. No.: 19/482,702

(22) PCT Filed: May 8, 2024
(86) PCT No.: PCT/US2024/028321

§ 371 Date: Nov. 7, 2025

(30) Foreign Application Priority Data
Jul. 4, 2023 (GR) 20230100540

(51) Int. Cl. G06N 3/098; G06N 3/045

(52) U.S. Cl. CPC G06N 3/098; G06N 3/045

(57) ABSTRACT

Certain aspects are directed to implementation of a contrastive learning model in a federated learning environment. In certain aspects, a wireless node may be configured to input a data point into a first neural network configured to output a feature of the data point. In certain aspects, the wireless node may be configured to input the feature into a second neural network and a third neural network, wherein the second neural network is configured to output a predicted client identifier based on the feature, wherein the predicted client identifier is indicative of a predicted source of the data point, and wherein the third neural network is associated with a contrastive loss computation of the data point.

### CROSS-REFERENCE TO RELATED APPLICATIONS

This application claims the benefit of Greek patent application No. 20230100540 titled “CONTRASTIVE LEARNING IN A FEDERATED ENVIRONMENT,” filed Jul. 4, 2023, which is incorporated herein by reference in its entirety.

### BACKGROUND

### Technical Field

The present disclosure generally relates to machine learning, and more particularly, to contrastive learning in a federated environment.

### INTRODUCTION

Machine learning may produce a trained model (e.g., an artificial neural network, a tree, or other structures), which represents a generalize fit to a set of training data that is known a priori. Applying the trained model to new data produces inferences, which may be used to gain insights into the new data. In some cases, applying the model to the new data is described as “running an inference” on the new data.

Machine learning models are seeing increased adoption across myriad domains, including for use in classification, detection, and recognition tasks. For example, machine learning models are being used to perform complex tasks on electronic devices based on sensor data provided by one or more sensors onboard such devices, such as automatically classifying features (e.g., faces) within images.

One machine learning model is called a “centralized learning” model. In centralized machine learning, an electronic communication device or “edge device” (e.g., a mobile phone, laptop, tablet, desktop computer, smart TV, client server, etc.) is communicatively connected to a central server and configured to upload local data to the server. The central server typically performs all the computational tasks necessary to train the data. While centralized training is computationally-efficient for the participating clients who are free from the computation responsibilities, the clients' private data is also collected which can cause a privacy risk for the client.

Another machine learning model is called a “federated learning” model that uses a decentralized training process. In some examples, multiple edge devices download a model (e.g., a pre-trained foundation model) from a central server. The edge devices then train the model on their private data to generate a new configuration of the model. The edge devices then summarize and encrypt their corresponding new model configurations and send them back to the server to be decrypted, averaged, and integrated into an updated model. Iteration after iteration, the collaborative training continues until the model is fully trained.

There exists a need for further improvements in machine learning technology. These improvements may be applicable to different types of machine learning models, including federated learning models.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects of the disclosure are directed to a method for training a federated contrastive learning model. In some examples, the method includes inputting a data point into a first neural network configured to output a feature of the data point. In some examples, the method includes inputting the feature into a second neural network and a third neural network, wherein the second neural network is configured to output a predicted client identifier based on the feature, wherein the predicted client identifier is indicative of a predicted source of the data point, and wherein the third neural network is associated with a contrastive loss computation of the data point. In some examples, the method includes outputting: the contrastive loss computation, and a client identifier loss computation based on comparing the predicted client identifier to an actual client identifier, wherein the actual client identifier is indicative of an actual source of the data point.

Aspects of the disclosure are directed to an apparatus configured to train a federated contrastive learning model. In some examples, the apparatus includes a memory and at least one processor coupled to the memory. In some examples, the memory includes instructions configured to cause the apparatus to input a data point into a first neural network configured to output a feature of the data point. In some examples, the memory includes instructions configured to cause the apparatus to input the feature into a second neural network and a third neural network, wherein the second neural network is configured to output a predicted client identifier based on the feature, wherein the predicted client identifier is indicative of a predicted source of the data point, and wherein the third neural network is associated with a contrastive loss computation of the data point. In some examples, the memory includes instructions configured to cause the apparatus to output: the contrastive loss computation, and a client identifier loss computation based on comparing the predicted client identifier to an actual client identifier, wherein the actual client identifier is indicative of an actual source of the data point.

Certain aspects are directed to an apparatus configured to train a federated contrastive learning model. In some examples, the apparatus includes means for inputting a data point into a first neural network configured to output a feature of the data point. In some examples, the apparatus includes means for inputting the feature into a second neural network and a third neural network, wherein the second neural network is configured to output a predicted client identifier based on the feature, wherein the predicted client identifier is indicative of a predicted source of the data point, and wherein the third neural network is associated with a contrastive loss computation of the data point. In some examples, the apparatus includes means for outputting: the contrastive loss computation, and a client identifier loss computation based on comparing the predicted client identifier to an actual client identifier, wherein the actual client identifier is indicative of an actual source of the data point.

Certain aspects are directed to a computer-readable medium storing computer executable code. In some examples, the code when executed by a processor causes the processor to input a data point into a first neural network configured to output a feature of the data point. In some examples, the code when executed by a processor causes the processor to input the feature into a second neural network and a third neural network, wherein the second neural network is configured to output a predicted client identifier based on the feature, wherein the predicted client identifier is indicative of a predicted source of the data point, and wherein the third neural network is associated with a contrastive loss computation of the data point. In some examples, the code when executed by a processor causes the processor to output the contrastive loss computation, and a client identifier loss computation based on comparing the predicted client identifier to an actual client identifier, wherein the actual client identifier is indicative of an actual source of the data point.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating an example of a base station and user equipment (UE) in an access network.

FIG. 3 is an example of a wireless network communicating in a federated learning environment.

FIG. 4 is a diagram conceptually illustrating an example of a contrastive learning process.

FIG. 5 is a diagram conceptually illustrating an example of a contrastive learning process in a federated learning system.

FIG. 6 is a diagram conceptually illustrating an example of a contrastive learning process in a federated learning system.

FIG. 7 is a flowchart illustrating of a method of implementing a contrastive learning process in a federated learning system.

FIG. 8 is a diagram illustrating another example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of machine learning models and systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

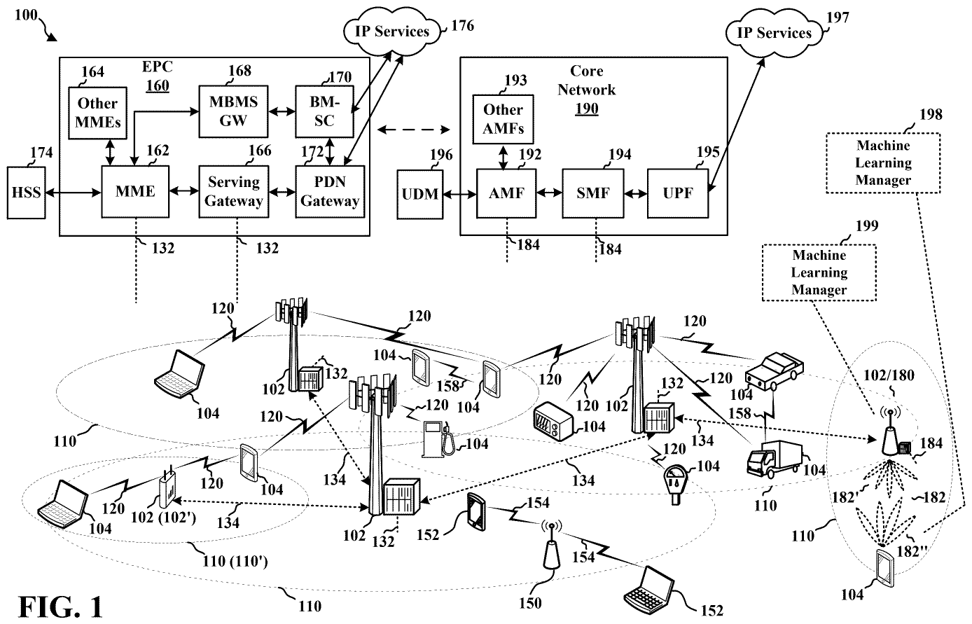

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A wireless node may comprise a computing device configured as one of an edge/client device, (e.g., a UE, laptop/desktop computer, a surface device, or any other suitable personal computing device) or a base station, network entity, or any other suitable external device configured for communication with the edge/client device.

Some UEs and base stations may be configured as edge devices, machine-type communication (MTC) devices, or evolved or enhanced machine-type communication (eMTC) devices configured to perform machine learning processes. MTC and eMTC devices may include, for example, robots, drones, remote devices, sensors, meters, monitors, and/or location tags, that may communicate with a base station, another device (e.g., remote device), or some other entity.

As shown in FIG. 1, the UE 104 may include a first machine learning (ML) manager 198. As described in more detail elsewhere herein, the first ML manager 198 may input a data point into a first neural network configured to output a feature of the data point. The first ML manager 198 may input the feature into a second neural network and a third neural network, wherein the second neural network is configured to output a predicted client identifier based on the feature, wherein the predicted client identifier is indicative of a predicted source of the data point, and wherein the third neural network is associated with a contrastive loss computation of the data point. The first ML manager 198 may output: the contrastive loss computation, and a client identifier loss computation based on comparing the predicted client identifier to an actual client identifier, wherein the actual client identifier is indicative of an actual source of the data point. Additionally, or alternatively, the first ML manager 198 may perform one or more other operations described herein.

The base station 102/180 may include a second ML manager 199. As described in more detail elsewhere herein, the second ML manager 199 may input a data point into a first neural network configured to output a feature of the data point. The second ML manager 199 may input the feature into a second neural network and a third neural network, wherein the second neural network is configured to output a predicted client identifier based on the feature, wherein the predicted client identifier is indicative of a predicted source of the data point, and wherein the third neural network is associated with a contrastive loss computation of the data point. The second ML manager 199 may output: the contrastive loss computation, and a client identifier loss computation based on comparing the predicted client identifier to an actual client identifier, wherein the actual client identifier is indicative of an actual source of the data point. Additionally, or alternatively, the second ML manager 199 may perform one or more other operations described herein.

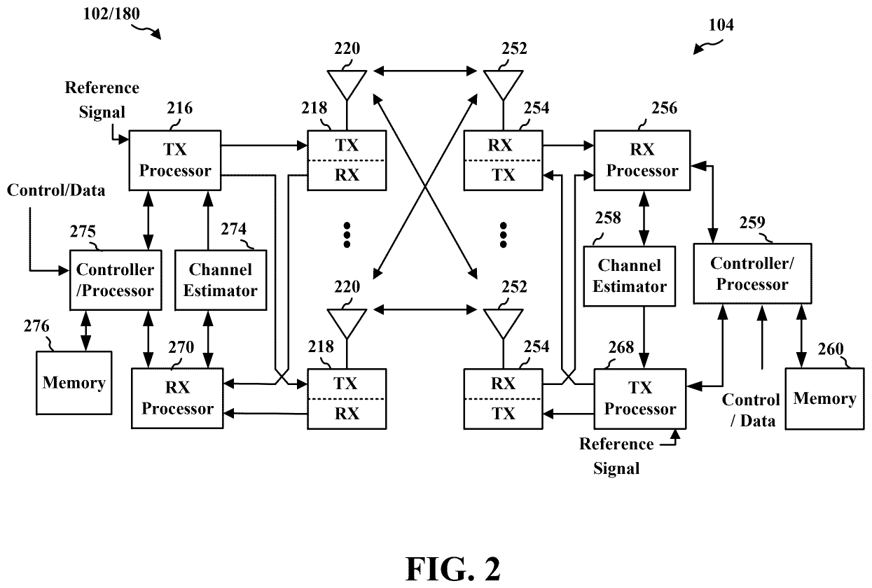

FIG. 2 is a block diagram of a base station 102/180 in communication with a UE 104 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 104. Each spatial stream may then be provided to a different antenna 220 via a separate transmitter 218TX. Each transmitter 218TX may modulate an RF carrier with a respective spatial stream for transmission.

At the UE 104, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 104. If multiple spatial streams are destined for the UE 104, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102. These soft decisions may be based on channel estimates computed by the channel estimator 258. The soft decisions are then decoded and deinterleaved to recover the data and control signals that were originally transmitted by the base station 102 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 102, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 102 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission.

The UL transmission is processed at the base station 102 in a manner similar to that described in connection with the receiver function at the UE 104. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 104. IP packets from the controller/processor 275 may be provided to the EPC 160. The controller/processor 275 is also responsible for error detection using an ACK and/or NACK protocol to support HARQ operations.

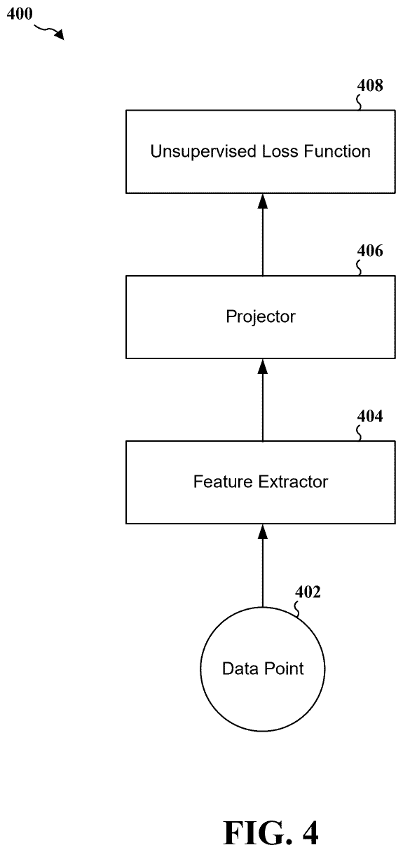

Controller/processor 275 of base station 102/180, controller/processor 259 of UE 104, and/or any other component(s) of FIG. 2 may perform one or more techniques associated with signaling and capabilities to enable federated learning and switching between machine learning and non-machine learning tasks, as described in more detail elsewhere herein. For example, controller/processor 275 of base station 102/180, controller/processor 259 of UE 104, and/or any other component(s) of FIG. 2 may perform or direct operations of, for example, processes of FIGS. 4-7 and/or other processes as described herein. For example, FIGS. 4-7 conceptually illustrate a framework for contrastive learning in a federated learning environment. Memories 260 and 276 may store data and program codes for base station 102/180 and UE 104, respectively. In some aspects, memory 260 and/or memory 276 may include a non-transitory computer-readable medium storing one or more instructions (e.g., code and/or program code) for executing code for contrastive learning in a federated environment. For example, the one or more instructions, when executed (e.g., directly, or after compiling, converting, and/or interpreting) by one or more processors of the base station 102/180 and/or the UE 104, may cause the one or more processors, the UE 104, and/or the base station 102/180 to perform or direct operations of, for example, processes illustrated in FIGS. 4-7 and/or other processes as described herein. In some aspects, executing instructions may include running the instructions, converting the instructions, compiling the instructions, and/or interpreting the instructions, among other examples.

### Examples of Federated Machine Learning

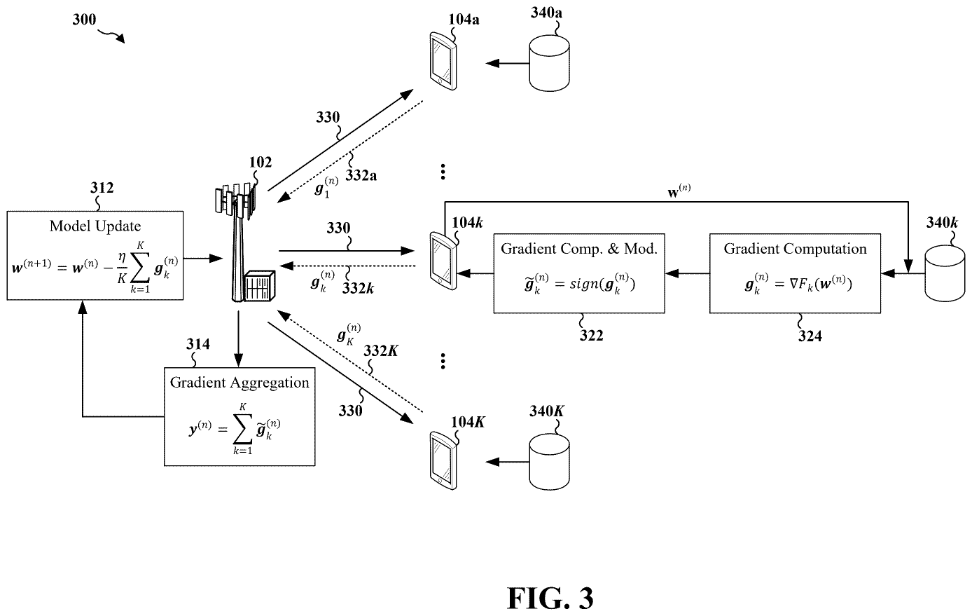

FIG. 3 is a diagram illustrating an example over-the-air (OTA) federated learning system 300 in a wireless network, in accordance with the present disclosure.

Machine learning components are being used more and more to perform a variety of different types of operations. A machine learning component may include a software component of a UE (e.g., a client device, an edge device, and/or a server device) and/or a base station (e.g., a centralized server) that performs one or more machine learning procedures and/or that works with one or more other software and/or hardware components to perform one or more machine learning procedures in a machine learning mode. In one or more examples, a machine learning component may include, for example, software that may learn to perform a procedure without being explicitly trained to perform the procedure. A machine learning component may include, for example, a feature learning processing block (e.g., a software component that facilitates processing associated with feature learning) and/or a representation learning processing block (e.g., a software component that facilitates processing associated with representation learning). A machine learning component may include one or more neural networks, one or more classifiers, and/or one or more deep learning models, among other examples.

In one or more examples, machine learning components may be distributed within a network. For example, a server device may provide a machine learning component to one or more client devices. The machine learning component may be trained using federated learning. Federated learning (also known as collaborative learning) is a machine learning technique that enables multiple clients to collaboratively train machine learning components in a decentralized manner. In federated learning, a client device may use local training data to perform a local training operation associated with the machine learning component. For example, the client device may use local training data to train the machine learning component. Local training data is training data that is generated by, collected by, and/or stored at the client device without being exchanged with other nodes that are participating in the federated learning.

In federated learning, a client device may generate a local update associated with the machine learning component based at least in part on the local training operation. A local update is information associated with the machine learning component that reflects a change to the machine learning component that occurs as a result of the local training operation. For example, a local update may include the locally updated machine learning component (e.g., updated as a result of the local training operation), data indicating one or more aspects (e.g., parameter values, output values, weights) of the locally updated machine learning component, a set of gradients associated with a loss function corresponding to the locally updated machine learning component, and/or a set of parameters (e.g., neural network weights) corresponding to the locally updated machine learning component, among other examples.

In federated learning, the client device may provide the local update to the server device. The server device may collect local updates from one or more client devices and use the local updates to update a global version of the machine learning component that is maintained at the server device. An update associated with the global version of the machine learning component that is maintained at the server device may be referred to as a global update. A global update is information associated with the machine learning component that reflects a change to the machine learning component that occurs based at least in part on one or more local updates and/or a server update. A server update is information associated with the machine learning component that reflects a change to the machine learning component that occurs as a result of a training operation performed by the server device. In one or more examples, a server device may generate a global update by aggregating a number of local updates to generate an aggregated update and applying the aggregated update to the machine learning component.

In some aspects, after collecting the local updates from the client device(s) and using the local updates to update the global version of the machine learning component, the server device may provide the global update to the client device(s). A client device may apply a global update received from a server device to the machine learning component (e.g., to the locally-stored copy of the machine learning component). In this way, a number of client devices may be able to contribute to the training of a machine learning component and a server device may be able to distribute global updates so that each client device maintains a current, updated version of the machine learning component. Federated learning also may facilitate privacy of training data because the server device may generate global updates based on local updates and without collecting the local training data associated with the client devices.

In some cases, the exchange of information in federated learning may be performed over wireless local area network (WLAN) connections, where limited and/or costly communication resources may be of relatively low concern due to wired connections associated with modems, routers, and/or other network infrastructure. However, implementing federated learning using machine learning components in a cellular context may improve network performance and user experience in a wireless network. In the cellular context, for example, a centralized server device may be, include, or be included in a base station, and a client device may be, include, or be included in a UE. Accordingly, in a wireless network, such as an LTE network or an NR network, a UE operating in a network may utilize a machine learning component for any number of different types of operations, transmissions, user experience enhancements, and/or the like. For example, in some cases, a base station may configure a UE to perform one or more tasks (e.g., related to wireless communication, positioning, and/or user interface interactions, among other examples) in a machine learning mode and to report information associated with the machine learning tasks to the base station. For example, in the machine learning mode, a UE may be configured to obtain measurements associated with downlink reference signals (e.g., a channel state information reference signal (CSI-RS), transmit an uplink reference signal (e.g., a sounding reference signal (SRS)), measure reference signals during a beam management process for providing channel state feedback (CSF) in a channel state information (CSI) report, measure received power of reference signals from a serving cell and/or neighbor cells, measure signal strength of inter-radio access technology (e.g., WLAN) networks, measure sensor signals for detecting locations of one or more objects within an environment, and/or collect data related to user interactions with the UE, among other examples. In this way, federated learning may enable improvements to network performance and/or user experience by leveraging the local machine learning capabilities of one or more UEs.

For example, as shown in FIG. 3, a base station 102 (e.g., gNB) or a disaggregated network entity associated with a base station shares a global federated learning model 330 with a group of user equipment (UEs) 104 (e.g., 104a, 104k, 104K) participating in the federated learning process. In these configurations, the model parameters are optimized by the federated learning system 300. The model parameters w⁽ⁿ⁾ represent biases and weights of the global federated learning model 330, g⁽ⁿ⁾ represents a gradient estimate, where nis a federated learning round index. For example, the initial model parameters may be designated as w⁽⁰⁾.

In these configurations, the UEs 104 each include a local dataset 340 (e.g., 340a, 340k, 340K), a gradient computation block 324, and a gradient compression and modulation block 322. In this example, the gradient computation block 324 of a second UE 104k is configured to perform a local update through decentralized stochastic gradient descent (SGD). Each of the UEs 104 performs some type of training iteration, such as a single stochastic gradient descent step or multiple stochastic gradient descent steps as seen in equation (1):

$${g}_{k}^{( n )} = ∇ {F}_{k} ( {w}^{( n )} ) \qquad Equation 1$$

Where ∇Fₖ(w⁽ⁿ⁾) represents a local loss function for a weight w for the nth federated learning round, and

$${g}_{k}^{( n )}$$

represents a local gradient for the nth federated learning round.

After the UEs 104 have completed the local gradients

$${g}_{k}^{( n )} ,$$

the gradient compression and modulation block 322 may compress and modulate the computed gradient vector

$${g}_{k}^{( n )}$$

as seen in equation (2), to obtain the compressed values

$${\tilde{g}}_{k}^{( n )}$$

### 332 (e.g., 332a, 332k, 332K):

$${\tilde{g}}_{k}^{( n )} = sign ( {g}_{k}^{( n )} ) \qquad Equation 2$$

The UEs 104 feedback the computed compressed gradient vectors

$${\tilde{g}}_{k}^{( n )}$$

332 to the base station 102. This federated learning process includes transmission of the computed compressed gradient vectors

$${\tilde{g}}_{k}^{( n )}$$

332 from all the UEs 104 to the base station 102 in each round of the process.

In these configurations, the base station 102 includes a gradient aggregation block 312 configured to aggregate the computed compressed gradient vectors

$${\tilde{g}}_{k}^{( n )}$$

332. Although aggregation is shown, other types of averaging are also contemplated. Here, a UE 104 may transmit the updated gradient based on a coefficient of the channel used for transmission (e.g., channel state information (CSI)). As such, the combination of signals received by the base station 102 at the nth communication round may be given as shown in equation (3):

$${r}^{( n )} = {\sum }_{k = 1}^{K} {h}_{k}^{( n )} \frac{{g}_{k}^{( n )}}{{h}_{k}^{( n )}} = {\sum }_{k = 1}^{K} {g}_{k}^{( n )} \qquad Equation 3$$

Where r⁽ⁿ⁾ is the gradient update signal received by the base station 102, and

$${h}_{k}^{( n )}$$

the channel pre-compensation applied to the transmission by the UE 104.

In addition, a model update block 314 is configured to update parameters of the global federated learning model 330, where n represents a learning rate, which is a parameter of the global federated learning model 330. The updated model is then sent to all of the UEs 104. This process repeats until a global federated learning accuracy specification is met (e.g., until a global federated learning algorithm converges). An accuracy specification may refer to a desired accuracy level for local training. For example, an accuracy specification may indicate that a local training loss in each iteration of the federated learning process should drop below a threshold.

According to aspects of the disclosure, a UE 104 may communicate its local gradient updates

$${g}_{k}^{( n )} ,$$

and the base station 102 may receive and combine the local gradients via non-coherent orthogonal modulation. As such, the UE 104 is not required to modify or apply a pre-compensation to its transmission of a gradient update based on a uplink channel state information (CSI). Accordingly, if the UE 104 does not have access to uplink channel CSI or other uplink channel information, non-coherent orthogonal modulation may provide the UE 104 with a more convenient method of communication of local gradients.

### Examples of Contrastive Learning

Contrastive learning is a machine learning technique used to learn the general features of a dataset without labels (e.g., self-supervised learning) by teaching a model which data points are similar or different. For example, contrastive learning model may analyze which pairs of data points are “similar” and “different” in order to learn higher-level features about the data, before even having a task such as classification or segmentation. SimCLR is an example of a contrastive learning model and may be referred to throughout the disclosure. However, it should be noted that any suitable contrastive learning model may be used or modified as described throughout the disclosure.

In certain aspects, SimCLR may operate by taking an original data point (e.g., a visual representation of an object such as a digital image or video, an audio instance such as an audio file, a text file, or any other suitable domain), creating one or more augmented copies of the data point, and creating vector representations of each of the one or more augmented data points. In one example, augmenting a data point may include at least one of cropping, resizing, rotating, distorting color, etc. of the original data point. The purpose being to train the model to learn that the augmented data points are simply different versions of the original data point. The augmented data points may then be compressed into a latent space representation so that the model is able to detect vector similarities between the one or more augmented data points or between the original data point and the one or more augmented data points. Once the vector similarities are determined, the model may quantify the similarities between them using any suitable technique. For example, the model may perform a cosine similarity technique between two vectors, which is based on an angle between the two vectors in space. The smaller the angle between the two vectors (e.g., the closer to zero), the more similar the two vectors are.

In some examples, the contrastive model may perform a loss function to minimize via successive learning. In some examples, the loss function is an equation used to compute a probability that an augmented data point is similar to another augmented data point or to the original data point.

FIG. 4 is a diagram conceptually illustrating an example process 400 of contrastive learning. Initially, an original data point 402 is input into a feature extractor 404 which may create two augmented data points based on the original data point 402. The feature extractor 404 may be a neural network configured to create one or more augmented data points based on the original data point 402, and create vector representations of each of the one or more augmented data points. In some examples, the type and number of augmentations made to each of the augmented data points is random. The feature extractor 404 may then encode each of the augmented data points as vector representations (e.g., a tensor) and output the vector representations.

The output of the feature extractor 404 may then be input to a projector 406 configured to transform (e.g., compress) the vector representations into a representation in another space (e.g., a latent space representation). The projector 406 may then determine output one or more similar vectors.

The output of the projector 406 may then be input to an unsupervised loss function 408 configured to compute one or more of a probability that the two augmented data points are similar and/or a loss.

Thus, contrastive learning compares unlabeled data points (e.g., images containing subjects that are not identified) to compute a loss estimate based on comparing a representative sample of data points in a pair-wise fashion. It should be noted that unsupervised or self-supervised training methods such as those described above have been successfully applied to non-federated machine learning (e.g., centralized learning models), self-supervised learning has been relatively less successful when applied to federated learning. Part of the reason for this is independent identically distributed data in a centralized learning setting. For example, centralized learning typically has access to all the data points and thus, holds the assumption that a given client's data is independent identically distributed. In contrast, data in a federated learning setting is not independent identically distributed data, meaning that the datasets across different clients may have different characteristics. This lack of independent identically distributed data in federated learning setting may affect the performance of contrastive learning models in a federated setting. Thus, aspects of the disclosure are directed to optimizing contrastive learning techniques in a federated learning environment.

### Examples of Contrastive Learning in a Federated Learning Environment

Examples described below are directed to techniques for applying contrastive learning (e.g., SimCLR and any other suitable contrastive learning techniques) in a federated learning environment.

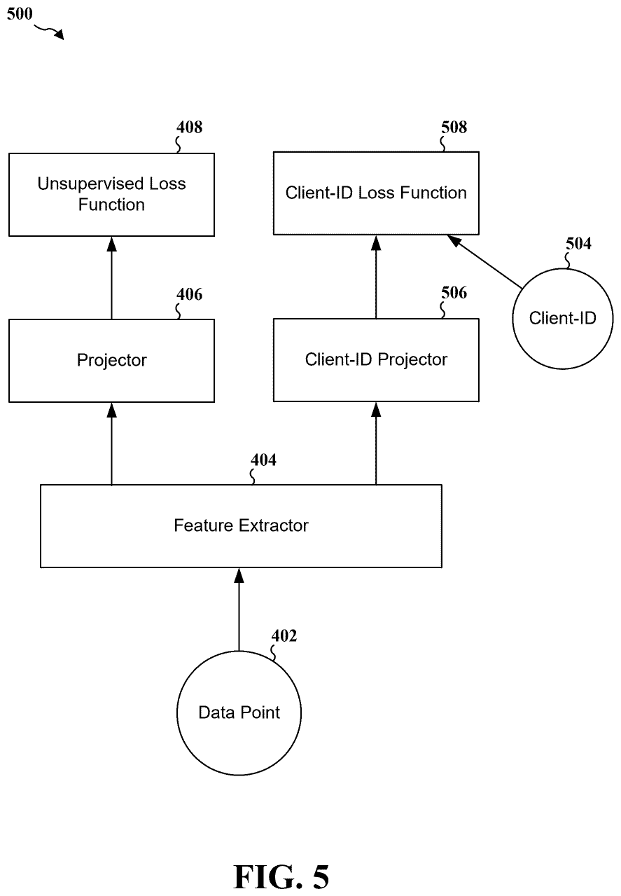

FIG. 5 is a diagram conceptually illustrating an example process 500 of contrastive learning in an unsupervised federated learning environment. Here, the process 500 includes several steps illustrated and described above in reference to FIG. 4 (e.g., data point 402, feature extractor 404, projector 406, and an unsupervised loss function 408). The process 500 of FIG. 5 includes additional aspects, including an actual client ID 504, a client ID projector 506, and a client ID loss function 508.

The client ID projector 506 may be implemented as a neural network configured to predict a client ID associated with the data point 402 based on the output of the feature extractor (e.g., predict the client ID based on the features extracted from the data point). For example, the client ID projector 506 may receive, as an input, the output of the feature extractor. The client ID projector 506 may output a predicted client ID.

The client-ID loss function 508 may receive, as input, the predicted client ID or an indication of the predicted client ID. The client-ID loss function 508 may then compare the predicted client ID to the actual client ID 504 associated with the data point 402 to determine if the predicted client ID was correctly predicted by the client ID projector 506. In other words, the data point 402 may originate from a particular client, or the particular client is the source of the data point 402. Thus, that particular client ID is the actual client ID 504 and is an input for the client ID loss function 508. The client ID loss function 508 may then output a loss calculated based on comparing the predicted client ID with the actual client ID 504.

The processes described above and associated with the actual client ID 504, the client ID projector 506, and the client ID loss function 508 may be performed in parallel or concurrently with the processes illustrated in FIG. 4.

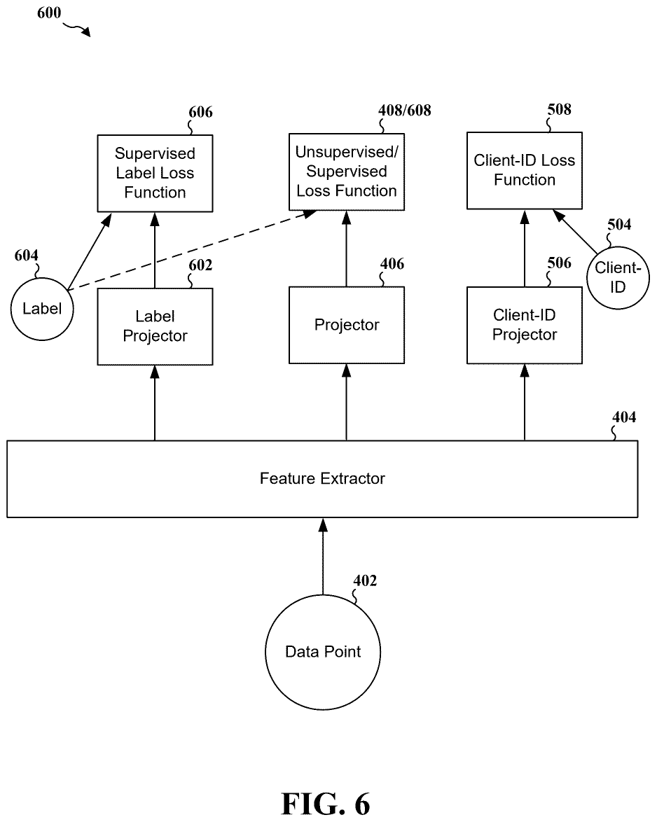

FIG. 6 is a diagram conceptually illustrating an example process 600 of contrastive learning in a semi-supervised or fully supervised federated learning environment. Here, the process 600 includes several steps illustrated and described above in reference to FIGS. 4 and 5 (e.g., data point 402, feature extractor 404, projector 406, actual client ID 504, a client ID projector 506, and a client ID loss function 508. The process 600 of FIG. 6 includes additional aspects, including a label projector 602, an actual label 604, a supervised label loss function 606, and a supervised loss function 608.

Here, the label projector 602 may receive, as input, data output by the feature extractor 404. Based on the received data, the label projector may predict an appropriate label for the data point 402. The label projector 602 may output the predicted label or an indication of the predicted label, and the supervised label loss function 606 may receive the predicted label as an input. The supervised label loss function 606 may also receive an actual label 604 associated with the data point 402 as an input. The supervised label loss function 606 may then compare the actual label 604 with the predicted label and calculate a loss based on how accurate the predicted label is in relation to the actual label 604.

The process 600 of FIG. 6 may use either an unsupervised loss function 408 of FIGS. 4 and 5, or a supervised loss function 608. The supervised loss function 608 may receive, as input, data output by the projector 406 and the actual label 604 associated with the data point 402. More specifically, a client device (e.g., a UE) may have stored data points of which at least one or more do not have corresponding labels. For example, a client's UE may include a catalog of pictures stored on the UE, of which no picture (e.g., a data point configured as a visual representation) has a label or less than all of the pictures include a label. In such an example, the process 600 may use a batch or group of data points that share a common label. In one example, a client device may have 1000 pictures of various subjects. In the unsupervised process of FIGS. 4 and 5, the contrastive learning model may analyze all the pictures regardless of any labels associated with one or more of the pictures. However, if a label is associated with at least a subset of the 1000 pictures, then the subject(s) of the subset of pictures is known, and the subset of pictures can be divided into groups according to their labels. For example, a user client may have 1000 data points of which a subset of 800 data points are labeled. 400 data points of the subset are labeled “cat” while the other 400 data points of the subset are labeled “dog.” Here, the supervised loss function 608, the feature extractor 404, and the projector 406 may process only data points having the same label. For instance, the supervised loss function 608, the feature extractor 404, and projector 406 would first analyze 400 data points of cat/dog, before analyzing the other 400 of dog/cat. Thus, data points having different labels may be analyzed as groups of the same label, separate from groups of data points having a different label.

It should be noted that the input of the actual label 604 is optional and may depend on whether the process 600 uses the unsupervised loss function 408 or the supervised loss function 608. In some examples, the process of FIGS. 4-6 may be performed on an edge device or client device (e.g., a UE), or the process may be performed at a base station, a network entity, or any other suitable device external to the client device.

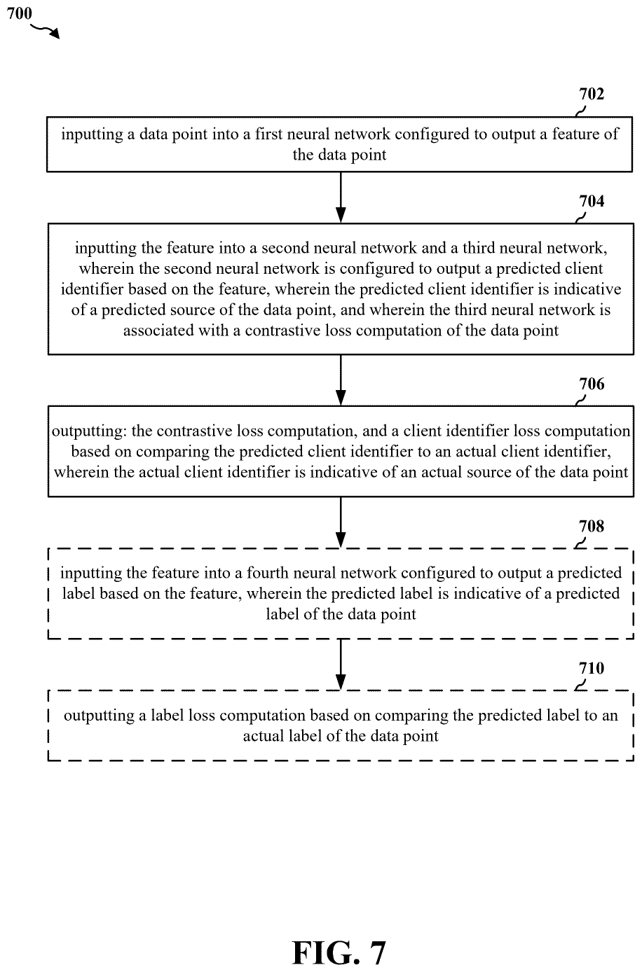

FIG. 7 is a flowchart 700 of a method processing a data point using a federated contrastive learning model. The method may be performed by a wireless node (e.g., the UE 104; the base station 102/180; the apparatus 802). At 702, the wireless node may input a data point into a first neural network configured to output a feature of the data point. For example, 902 may be performed by a feature extractor component 840. Here, the wireless node may input a data point (e.g., data point 402 of FIGS. 4-6) into a feature extractor (e.g., feature extractor 404 of FIGS. 4-6). Here, the feature extractor may extract a feature, such as a vector representation of a portion of the data point (e.g., a tensor).

At 704, the wireless node may input the feature into a second neural network and a third neural network, wherein the second neural network is configured to output a predicted client identifier based on the feature, wherein the predicted client identifier is indicative of a predicted source of the data point, and wherein the third neural network is associated with a contrastive loss computation of the data point. For example, 704 may be performed by a projector component 842. Here, the feature output from the feature extractor may be used as an input to the second neural network (e.g., the client ID projector 506 of FIGS. 5 and 6) and as an input to the third neural network (e.g., the projector 406 of FIGS. 4-6). The client ID projector may be configured to predict a client ID based on the feature (e.g., vector representations output by the feature extractor), or another identifier of a client that is predicted to be the source of the data point. The projector may be configured to transform the vector representations into a representation in another space and output one or more similar vectors for a contrastive loss computation.

At 706, the wireless node may output: (i) the contrastive loss computation, and (ii) a client identifier loss computation based on comparing the predicted client identifier to an actual client identifier, wherein the actual client identifier is indicative of an actual source of the data point. For example, 706 may be performed by a loss component 844. Here, the output of the projector (e.g., the projector 406 of FIGS. 4-6) may output one or more similar vectors to a loss function (e.g., unsupervised loss function 408 or supervised loss function 608) to compute a loss based on the similar vectors. The output of the client ID projector 506 may provide an input to another loss function (e.g., the client ID loss function 508). The client ID loss function may provide an indication of a loss based on whether the client ID projector 506 was capable of predicting a correct client ID associated with the data point 402.

At 708, the wireless node may optionally input the feature into a fourth neural network configured to output a predicted label based on the feature, wherein the predicted label is indicative of a predicted label of the data point. For example, 708 may be performed by the projector component 842. Here, the output of the feature extractor may be provided as an input to a label projector (e.g., label projector 602 of FIG. 6). The label projector may predict a label for the data point based on the feature provided by the feature extractor 404. The output of the label projector (e.g., a predicted label) may be provided as an input to a supervised label loss function (e.g., supervised label loss function 606 of FIG. 6). The supervised label loss function may compare the predicted label to an actual label of the data point to compute a loss based on whether the predicted label matches or is similar/dissimilar to the predicted label.

At 710, the wireless node may optionally output a label loss computation based on comparing the predicted label to an actual label of the data point. For example, 710 may be performed by a loss component 844. Here, the supervised label loss function may output the computed loss. It should be noted that 708 and 710 may be performed as part of a semi-supervised or supervised contrastive learning model, whereas 702, 704, and 706, without 708 and 710, may be performed as an unsupervised contrastive learning model.

In certain aspects, the federated contrastive learning model is a framework for contrastive learning of at least one of visual representations, audio, or text, and wherein the data point is a visual representation, an audio instance, or a text. For example, the data point may include a digital image, digital video, an audio file, or a text file stored on the wireless node.

In certain aspects, the data point is one of a group of multiple data points, wherein each data point in the group of multiple data points comprises the actual label. For example, 708 and 710 may be performed on multiple data points, wherein each of the multiple data points are part of a group of data points all having the same label.

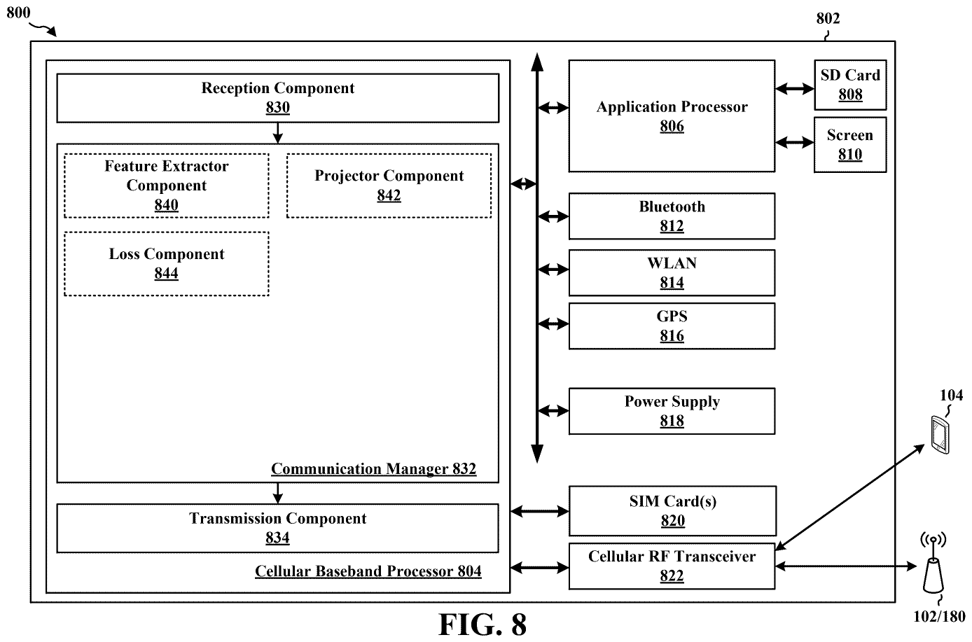

FIG. 8 is a diagram 800 illustrating an example of a hardware implementation for an apparatus 802. The apparatus 802 is a wireless node and includes a cellular baseband processor 804 (also referred to as a modem) coupled to a cellular RF transceiver 822 and one or more subscriber identity modules (SIM) cards 820, an application processor 806 coupled to a secure digital (SD) card 808 and a screen 810, a Bluetooth module 812, a wireless local area network (WLAN) module 814, a Global Positioning System (GPS) module 816, and a power supply 818. The cellular baseband processor 804 communicates through the cellular RF transceiver 822 with a UE 104 and/or BS 102/180. The cellular baseband processor 804 may include a computer-readable medium/memory. The computer-readable medium/memory may be non-transitory. The cellular baseband processor 804 is responsible for general processing, including the execution of software stored on the computer-readable medium/memory. The software, when executed by the cellular baseband processor 804, causes the cellular baseband processor 804 to perform the various functions described supra. The computer-readable medium/memory may also be used for storing data that is manipulated by the cellular baseband processor 804 when executing software. The cellular baseband processor 804 further includes a reception component 830, a communication manager 832, and a transmission component 834. The communication manager 832 includes the one or more illustrated components. The components within the communication manager 832 may be stored in the computer-readable medium/memory and/or configured as hardware within the cellular baseband processor 804. The cellular baseband processor 804 may be a component of the UE 104 and may include the memory 260 and/or at least one of the TX processor 268/216, the RX processor 256/270, and the controller/processor 259/275. In one configuration, the apparatus 802 may be a modem chip and include just the baseband processor 804, and in another configuration, the apparatus 802 may be the entire UE (e.g., see 104 of FIG. 2) or base station (e.g., see 102/180 of FIG. 2) and include the aforediscussed additional modules of the apparatus 802.

The communication manager 832 includes a feature extractor component 840 that is configured to input a data point into a first neural network configured to output a feature of the data point, e.g., as described in connection with 702 of FIG. 7.

The communication manager 832 further includes a projector component 842 that receives input from the feature extractor component 840 and is configured to input the feature into a second neural network and a third neural network, wherein the second neural network is configured to output a predicted client identifier based on the feature, wherein the predicted client identifier is indicative of a predicted source of the data point, and wherein the third neural network is associated with a contrastive loss computation of the data point; and input the feature into a fourth neural network configured to output a predicted label based on the feature, wherein the predicted label is indicative of a predicted label of the data point; e.g., as described in connection with 704 and 708 of FIG. 7.

The communication manager 832 further includes a loss component 844 that receives input from the projector component 842 and is configured to output: (i) the contrastive loss computation, and (ii) a client identifier loss computation based on comparing the predicted client identifier to an actual client identifier, wherein the actual client identifier is indicative of an actual source of the data point; and output a label loss computation based on comparing the predicted label to an actual label of the data point; e.g., as described in connection with 706 and 710 of FIG. 7.

The apparatus may include additional components that perform each of the blocks of the algorithm in the aforementioned flowcharts of FIG. 7. As such, each block in the aforementioned flowcharts may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 802, and in particular the cellular baseband processor 804, includes means for inputting a data point into a first neural network configured to output a feature of the data point.

In one configuration, the apparatus 802, and in particular the cellular baseband processor 804, includes means for inputting the feature into a second neural network and a third neural network, wherein the second neural network is configured to output a predicted client identifier based on the feature, wherein the predicted client identifier is indicative of a predicted source of the data point, and wherein the third neural network is associated with a contrastive loss computation of the data point.

In one configuration, the apparatus 802, and in particular the cellular baseband processor 804, includes means for outputting: the contrastive loss computation, and a client identifier loss computation based on comparing the predicted client identifier to an actual client identifier, wherein the actual client identifier is indicative of an actual source of the data point.

In one configuration, the apparatus 802, and in particular the cellular baseband processor 804, includes means for inputting the feature into a fourth neural network configured to output a predicted label based on the feature, wherein the predicted label is indicative of a predicted label of the data point.

In one configuration, the apparatus 802, and in particular the cellular baseband processor 804, includes means for outputting a label loss computation based on comparing the predicted label to an actual label of the data point.

The aforementioned means may be one or more of the aforementioned components of the apparatus 802 configured to perform the functions recited by the aforementioned means. As described supra, the apparatus 802 may include the TX Processor 268/216, the RX Processor 256/216, and the controller/processor 259/275.

### Additional Considerations

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### Example Aspects

The following examples are illustrative only and may be combined with aspects of other embodiments or teachings described herein, without limitation.

Example 1 is a method for training a federated contrastive learning model, comprising: inputting a data point into a first neural network configured to output a feature of the data point; inputting the feature into a second neural network and a third neural network, wherein the second neural network is configured to output a predicted client identifier based on the feature, wherein the predicted client identifier is indicative of a predicted source of the data point, and wherein the third neural network is associated with a contrastive loss computation of the data point; outputting: the contrastive loss computation, and a client identifier loss computation based on comparing the predicted client identifier to an actual client identifier, wherein the actual client identifier is indicative of an actual source of the data point.

Example 2 is the method of example 1, wherein the federated contrastive learning model is an unsupervised learning model.

Example 3 is the method of any of examples 1 and 2, wherein the feature is output as a tensor.

Example 4 is the method of any of examples 1-3, wherein the federated contrastive learning model is a framework for contrastive learning of at least one of visual representations, audio, or text, and wherein the data point is a visual representation, an audio instance, or a text.

Example 5 is the method of any of examples 1-4, wherein the method further comprises: inputting the feature into a fourth neural network configured to output a predicted label based on the feature, wherein the predicted label is indicative of a predicted label of the data point; and outputting a label loss computation based on comparing the predicted label to an actual label of the data point.

Example 6 is the method of example 5, wherein the data point is one of a group of multiple data points, wherein each data point in the group of multiple data points comprises the actual label.

Example 7 is the method of any of examples 5 and 6, wherein the federated contrastive learning model is a supervised or a semi-supervised learning model, and wherein the contrastive loss computation is based at least in part on the actual label.

Example 8 is a wireless entity comprising: a memory; and a processor coupled to the memory, the processor and memory being configured to perform the method of any of examples 1-7.

Example 9 is a wireless entity comprising one or more means for performing the method of any of examples 1-7.

Example 10 is a non-transitory computer-readable storage medium having instructions stored thereon for performing the method of any of examples 1-7 for wireless communication by a wireless entity.

1. A method for training a federated contrastive learning model, comprising:
inputting a data point into a first neural network configured to output a feature of the data point;
inputting the feature into a second neural network and a third neural network, wherein the second neural network is configured to output a predicted client identifier based on the feature, wherein the predicted client identifier is indicative of a predicted source of the data point, and wherein the third neural network is associated with a contrastive loss computation of the data point; and
outputting:
the contrastive loss computation, and
a client identifier loss computation based on comparing the predicted client identifier to an actual client identifier, wherein the actual client identifier is indicative of an actual source of the data point.

2. The method of claim 1, wherein the federated contrastive learning model is an unsupervised learning model.

3. The method of claim 1, wherein the feature is output as a tensor.

4. The method of claim 1, wherein the federated contrastive learning model is a framework for contrastive learning of at least one of visual representations, audio, or text, and wherein the data point is a visual representation, an audio instance, or a text.

5. The method of claim 1, wherein the method further comprises:
inputting the feature into a fourth neural network configured to output a predicted label based on the feature, wherein the predicted label is indicative of a predicted label of the data point; and
outputting a label loss computation based on comparing the predicted label to an actual label of the data point.

6. The method of claim 5, wherein the data point is one of a group of multiple data points, wherein each data point in the group of multiple data points comprises the actual label.

7. The method of claim 5, wherein the federated contrastive learning model is a supervised or a semi-supervised learning model, and wherein the contrastive loss computation is based at least in part on the actual label.

8. An apparatus configured to train a federated contrastive learning model, comprising:
a memory; and
at least one processor coupled to the memory and configured to:
input a data point into a first neural network configured to output a feature of the data point;
input the feature into a second neural network and a third neural network, wherein the second neural network is configured to output a predicted client identifier based on the feature, wherein the predicted client identifier is indicative of a predicted source of the data point, and wherein the third neural network is associated with a contrastive loss computation of the data point; and
output:
the contrastive loss computation, and
a client identifier loss computation based on comparing the predicted client identifier to an actual client identifier, wherein the actual client identifier is indicative of an actual source of the data point.

9. The apparatus of claim 8, wherein the federated contrastive learning model is an unsupervised learning model.

10. The apparatus of claim 8, wherein the feature is output as a tensor.

11. The apparatus of claim 8, wherein the federated contrastive learning model is a framework for contrastive learning of at least one of visual representations, audio, or text, and wherein the data point is a visual representation, an audio instance, or a text.

12. The apparatus of claim 8, wherein the at least one processor is further configured to:
input the feature into a fourth neural network configured to output a predicted label based on the feature, wherein the predicted label is indicative of a predicted label of the data point; and
output a label loss computation based on comparing the predicted label to an actual label of the data point.

13. The apparatus of claim 12, wherein the data point is one of a group of multiple data points, wherein each data point in the group of multiple data points comprises the actual label.

14. The apparatus of claim 12, wherein the federated contrastive learning model is a supervised or a semi-supervised learning model, and wherein the contrastive loss computation is based at least in part on the actual label.

15. An apparatus configured to train a federated contrastive learning model, comprising:
means for inputting a data point into a first neural network configured to output a feature of the data point;
means for inputting the feature into a second neural network and a third neural network, wherein the second neural network is configured to output a predicted client identifier based on the feature, wherein the predicted client identifier is indicative of a predicted source of the data point, and wherein the third neural network is associated with a contrastive loss computation of the data point; and
means for outputting:
the contrastive loss computation, and
a client identifier loss computation based on comparing the predicted client identifier to an actual client identifier, wherein the actual client identifier is indicative of an actual source of the data point.

16. The apparatus of claim 15, wherein the federated contrastive learning model is an unsupervised learning model.

17. The apparatus of claim 15, wherein the feature is output as a tensor.

18. The apparatus of claim 15, wherein the federated contrastive learning model is a framework for contrastive learning of at least one of visual representations, audio, or text, and wherein the data point is a visual representation, an audio instance, or a text.

19. The apparatus of claim 15, wherein the apparatus further comprises:
means for inputting the feature into a fourth neural network configured to output a predicted label based on the feature, wherein the predicted label is indicative of a predicted label of the data point; and
means for outputting a label loss computation based on comparing the predicted label to an actual label of the data point.

20. The apparatus of claim 19, wherein the data point is one of a group of multiple data points, wherein each data point in the group of multiple data points comprises the actual label.

21.-28. (canceled)
